(19) United States
(12) Patent Application Publication
(10) Pub. No.: US 2016/0297313 A1
(43) Pub. Date: Oct. 13, 2016

(54) POWER SYSTEM, VEHICLE AND POWER EQUIPMENT

(71) Applicant: TOYOTA JIDOSHA KABUSHIKI KAISHA, Toyota-shi (JP)

(72) Inventor: Tomoya ONO, Toyota-shi (JP)

(73) Assignee: TOYOTA JIDOSHA KABUSHIKI KAISHA, Toyota-shi (JP)

(21) Appl. No.: 14/991,130

(22) Filed: Jan. 8, 2016

(30) Foreign Application Priority Data
Apr. 9, 2015 (JP) 2015-080025

(51) Int. Cl. B60L 11/18

(52) U.S. Cl. CPC B60L 11/1838; B60L 11/1816; B60L 11/1861

(57) ABSTRACT

An electrically powered vehicle having a power storage device mounted thereon is externally charged by the electric power from power equipment, with the electrically powered vehicle being electrically connected to the power equipment by a power cable. When external charging is started on the basis of the time of a charging schedule, a time lag between a current time recognized by the electrically powered vehicle and a current time recognized by the power equipment is obtained at a timing of establishment of the connection by the power cable. Furthermore, charging start times that reflect the obtained time lag are separately set with respect to the current time in the electrically powered vehicle and the current time in the power equipment.

This nonprovisional application is based on Japanese Patent Application No. 2015-080025 filed on Apr. 9, 2015 with the Japan Patent Office, the entire contents of which are hereby incorporated by reference.

### BACKGROUND OF THE INVENTION

1Field of the Invention

The present invention relates to a power system, a vehicle and power equipment, and more particularly to a technique for power transmission between the vehicle and the power equipment in accordance with time setting.

2. Description of the Background Art

A technique for charging a power storage device mounted on an electric vehicle, a hybrid vehicle or the like by a power supply external to the vehicle (hereinafter also simply referred to as “external power supply”) is known. In the following description, charging of the power storage device mounted on the vehicle by the external power supply will also be simply referred to as “external charging”.

Japanese Patent Laying-Open No. 2014-011951 discloses that an optimum charging schedule is formulated with consideration given to a difference in electricity rate depending on the user's running start time and time period, and the time data in accordance with the charging schedule is shared within a network including a vehicle and power equipment.

Similarly, Japanese Patent Laying-Open No. 2012-070623 also discloses that a vehicle is externally charged in accordance with a charging schedule. Japanese Patent Laying-Open No. 2014-165998 discloses that external charging of a vehicle is performed by using an HEMS (Home Energy Management System).

### SUMMARY OF THE INVENTION

When external charging is performed in accordance with a charging schedule common to power equipment and a vehicle, the time data including a charging start time is shared and the operation of each of the power equipment and the vehicle is controlled.

However, in the case where there is a time lag between a clock of the power equipment and a clock of the vehicle, the charging start time may be recognized to have already gone by, when a notification of the charging start time is received. In such a case, there is a possibility that charging is not started until the charging start time on the following day comes. Particularly, in the case of starting charging immediately after formulation of the charging schedule, it is concerned that the aforementioned problem occurs due to the time lag between the clocks.

Japanese Patent Laying-Open No. 2014-165998 discloses that the electric power charged in a power storage battery for a vehicle is supplied to a power distribution board in a house. However, such power feeding from the vehicle may also cause a problem similar to the aforementioned problem when the power feeding is executed in accordance with a power feeding schedule based on time setting.

The present invention has been made to solve the aforementioned problem and an object of the present invention is to reliably execute power transmission between the power equipment and the vehicle in accordance with the common time schedule.

According to an aspect of the present invention, a power system includes: a vehicle having a power storage device mounted thereon; power equipment placed external to the vehicle; and a connection member that electrically connects the power equipment and the vehicle. The vehicle includes: a power converter; a first clock configured to detect a current time; and a first control device. The power converter is configured to execute at least one of first power conversion and a second power conversion. In the first power conversion, electric power supplied from the power equipment is converted into charging power of the power storage device. In the second power conversion, electric power from the power storage device is converted into feeding power to the power equipment. The first control device is configured to control at least one of a charging operation and a power feeding operation using the power converter. The power equipment includes: a second control device; and a second clock configured to detect a current time. The second control device is configured to control at least one of a supply operation and a reception operation. In the supply operation, the charging power is supplied to the vehicle to charge the power storage device. In the reception operation, the feeding power is received from the vehicle. The first and second control devices formulate at least one of a charging schedule and a power feeding schedule. The charging schedule defines a start time of charging from the power equipment to the power storage device. The power feeding schedule defines a start time of power feeding from the power storage device to the power equipment. The first and second control devices obtain a time lag between the first and second clocks when the vehicle and the power equipment are electrically connected by the connection member. Furthermore, in accordance with the time lag, the first and second control devices set a time difference between a first charging start time in the vehicle and a second charging start time in the power equipment or a time difference between a first power feeding start time in the vehicle and a second power feeding start time in the power equipment. Based on the current time detected by the first clock, the first control device starts the charging operation in the vehicle when the first charging start time comes or starts the power feeding operation in the vehicle when the first power feeding start time comes. Based on the current time detected by the second clock, the second control device starts the reception operation in the power equipment when the second charging start time comes or starts the supply operation in the power equipment when the second power feeding start time comes.

According to another aspect of the present invention, a vehicle having a power storage device mounted thereon includes: an inlet; a power converter; a clock configured to detect a current time; and a control device. The inlet is configured to be electrically connected via a connection member to power equipment placed external to the vehicle. The power converter is configured to execute at least one of first power conversion and second power conversion. In the first power conversion, electric power supplied from the power equipment is converted into charging power of the power storage device. In the second power conversion, electric power from the power storage device is converted into feeding power to the power equipment. The control device controls power transmission between the vehicle and the power equipment. Based on the current time detected by the clock, the control device starts a charging operation when detecting that a charging start time has come, or a power feeding operation when a power feeding start time has come. A time difference is set between the charging start time and a charging start time in the power equipment or between the power feeding start time and a power feeding start time in the power equipment. The time difference is set in accordance with a time lag between the current time detected by the clock and a current time recognized by the power equipment, when the vehicle and the power equipment are electrically connected by the connection member.

According to still another aspect of the present invention, power equipment executes at least one of a supply operation and a reception operation on a vehicle having a power storage device mounted thereon. In the supply operation, charging power is supplied to the vehicle to charge the power storage device. In the reception operation, feeding power is received from the vehicle. The power equipment includes: a power node; a clock configured to detect a current time; and a control device. The power node is configured to be electrically connected to the vehicle via a connection member. The control device is configured to control at least one of the supply operation and the reception operation. Based on the current time detected by the clock, the control device starts a charging operation when detecting that a charging start time has come, or a power feeding operation when a power feeding start time has come. A time difference is set between the charging start time and a charging start time in the vehicle or between the power feeding start time and a power feeding start time in the vehicle. The time difference is set in accordance with a time lag between the current time detected by the clock and a current time recognized by the power equipment, when the vehicle and the power equipment are electrically connected by the connection member.

Therefore, a main advantage of the present invention is that power transmission (external charging of the vehicle and/or external power feeding from the vehicle) can be reliably executed between the power equipment and the vehicle in accordance with the common time schedule, even when there is a time lag between the clocks.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram showing a configuration of a power system including a vehicle and power equipment according to a first embodiment of the present invention.

FIG. 2 is a block diagram for further describing a configuration of a power cable and the vehicle shown in FIG. 1.

FIG. 3 is a time chart for describing an operation for external charging of the vehicle shown in FIG. 2.

FIG. 4 is a block diagram for describing reception and transmission of information between the vehicle and the power equipment in the power system according to the present embodiment.

FIG. 5 is a flowchart describing a first example of a control process for external charging in the power system according to the first embodiment.

FIG. 6 is a flowchart describing a second example of the control process for external charging in the power system according to the first embodiment.

FIG. 7 is a flowchart describing a third example of the control process for external charging in the power system according to the first embodiment.

FIG. 8 is a flowchart describing a fourth example of the control process for external charging in the power system according to the first embodiment.

FIG. 9 is a block diagram describing a configuration of a vehicle in a power system according to a second embodiment.

FIG. 10 is a flowchart describing a first example of a control process for external power feeding in the power system according to the second embodiment.

FIG. 11 is a flowchart describing a second example of the control process for external power feeding in the power system according to the second embodiment.

FIG. 12 is a flowchart describing a third example of the control process for external power feeding in the power system according to the second embodiment.

FIG. 13 is a flowchart describing a fourth example of the control process for external power feeding in the power system according to the second embodiment.

FIG. 14 is a block diagram for describing a configuration of a vehicle according to a modification of the second embodiment.

### DESCRIPTION OF THE PREFERRED EMBODIMENTS

Embodiments of the present invention will be described in detail below with reference to the drawings, in which the same or corresponding portions are denoted by the same reference characters and description thereof will not be repeated. While a plurality of embodiments will be described, it is intended from the beginning in the present application to combine the configurations described in the embodiments as appropriate.

### First Embodiment

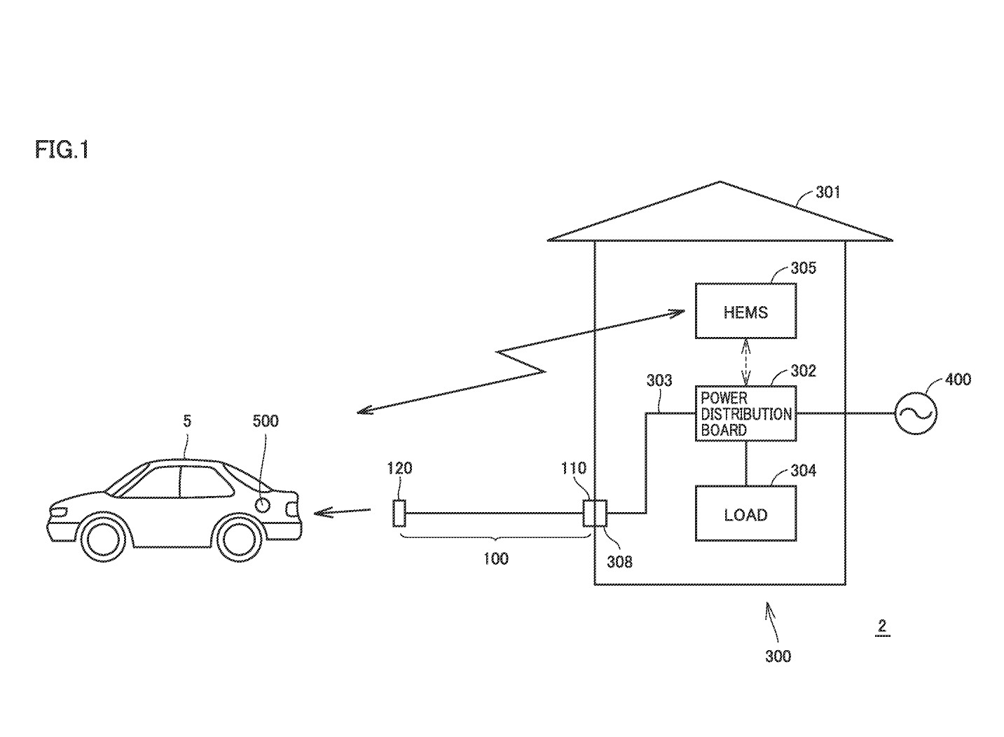

FIG. 1 is a block diagram of a power system including a vehicle and power equipment according to an embodiment of the present invention.

Referring to FIG. 1, a power system 2 has a vehicle 5 and power equipment 300. In a first embodiment, external charging of vehicle 5 in power system 2 will be described.

Power equipment 300 can be configured by, for example, power equipment for a house 301 that can receive and transmit the electric power from and to a system power supply 400. Power equipment 300 is not limited to the power equipment for a house, and may be provided in, for example, a building, a factory or the like. System power supply 400 is, for example, an AC power supply of 100 VAC or 200 VAC.

Power equipment 300 includes a power distribution board 302, a power line 303, an HEMS 305, and an electrical outlet 308. A load 304 is electrically connected to power distribution board 302 via an electrical outlet and the like. Load 304 generally represents various electric loads (such as an air conditioner) in house 301.

Power distribution board 302 is a device for distributing the electric power supplied from system power supply 400 to load 304 and power line 303. Electrical outlet 308 is electrically connected to power line 303. Therefore, the electric power distributed from power distribution board 302 to power line 303 can be supplied to a device electrically connected to electrical outlet 308.

Power distribution board 302 is provided with a power sensor (not shown) for measuring each of the electric power received from system power supply 400 and the electric power supplied to load 304 and vehicle 5, and a measurement value of each electric power is output to HEMS 305.

Power distribution board 302 is also provided with a control switch (not shown) controlled by HEMS 305, for performing power feeding and interruption of power feeding to load 304 and vehicle 5. Namely, power distribution board 302 is controlled by HEMS 305 and can control power feeding and interruption of power feeding to load 304 and vehicle 5. Power distribution board 302 may also be provided with a breaker for interrupting power reception from system power supply 400. Alternatively, the electric power from a not-shown solar battery may further be input to power distribution board 302.

HEMS 305 is configured to monitor power feeding from system power supply 400 to load 304 and vehicle 5, and execute display of a power feeding quantity and control of power feeding.

Vehicle 5 is, for example, any one of a hybrid vehicle, an electric vehicle and a fuel vehicle, and is configured such that the running driving force can be generated by using the electric energy. Therefore, as described below, a power storage device such as a secondary battery is mounted on vehicle 5. Vehicle 5 is provided with an inlet 500 for ensuring an electrical connection between vehicle 5 and the outside of vehicle 5.

A power cable 100 includes a plug 110 to be connected to electrical outlet 308 of power equipment 300, and a connector 120 to be connected to inlet 500 of vehicle 5. Plug 110 is connected to electrical outlet 308 and connector 120 is connected to inlet 500, and thus, vehicle 5 and power equipment 300 are electrically connected via power cable 100. As a result, a power transmission path is formed between vehicle 5 and power equipment 300. In the present embodiment, power cable 100 is shown as a representative example of “connection member” for electrically connecting vehicle 5 and power equipment 300.

In the present embodiment, power equipment 300 (HEMS 305) and vehicle 5 are configured to be capable of communicating with each other, and information and data can be received and transmitted between power equipment 300 (HEMS 305) and vehicle 5. Communication between HEMS 305 and vehicle 5 may be performed by power line communication (PLC) via power line 303 and power cable 100, or may be performed by wireless communication.

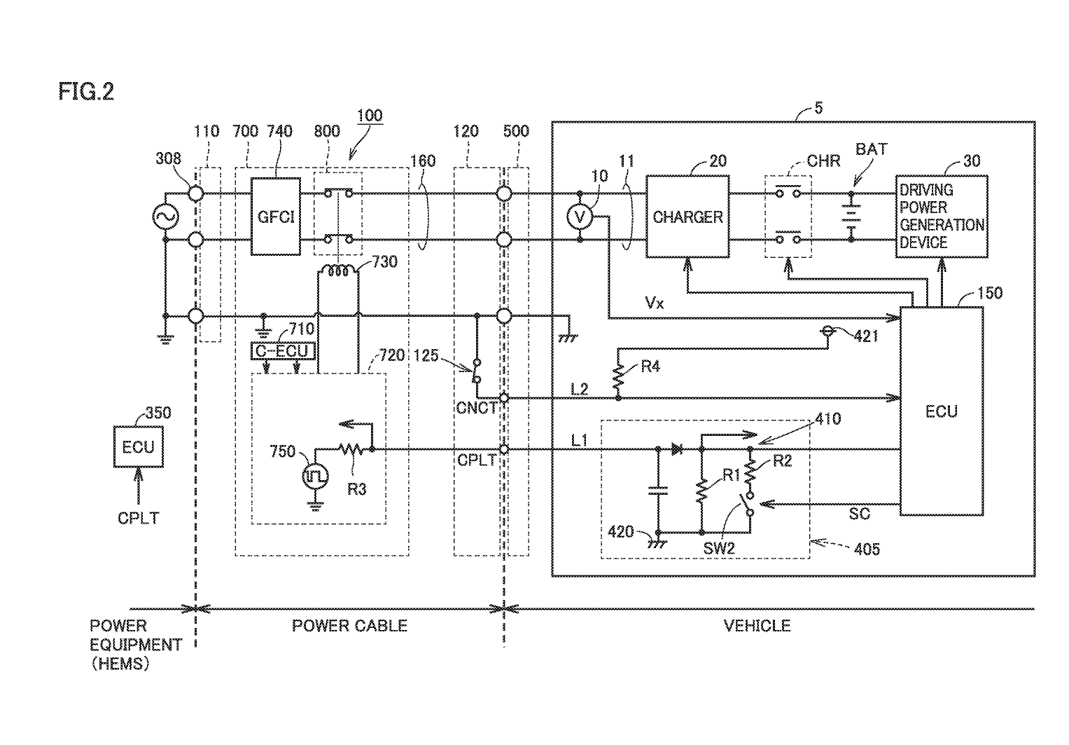

FIG. 2 is a block diagram for further describing a configuration of power cable 100 and vehicle 5 shown in FIG. 1.

Referring to FIG. 2, power cable 100 includes plug 110, connector 120, a power line 160, and a CCID (Charging Circuit Interrupt Device) 700.

Connector 120 is provided with a connection detector 125. Connection detector 125 is configured by, for example, a switch. This switch is turned on when connector 120 is connected to inlet 500, and is off when connector 120 is not connected.

In the ON state in which connector 120 is connected, a signal line L2 is connected to the ground, and thus, a voltage of signal line L2 changes. Therefore, on the vehicle 5 side, it can be detected whether or not connector 120 is in the connected state, by using a change in voltage of a connect signal CNCT caused by connection and removal of connector 120 and transmitted via inlet 500.

CCID 700 includes a C-ECU (Electronic Control Unit) 710, a control pilot circuit 720, an electromagnetic coil 730, a leakage detector 740, and a CCID relay 800.

C-ECU 710 includes a CPU (Central Processing Unit), a storage device (a random access memory (RAM), a read only memory (ROM), and the like), and an input/output buffer, all of which are not shown. C-ECU 710 has the function of receiving and transmitting a signal from and to control pilot circuit 720, and controlling the circuit operation in power cable 100.

Control pilot circuit 720 is configured to include an oscillation circuit 750 and a resistor element R3. Control pilot circuit 720 generates a pilot signal CPLT by using the electric power from power equipment 300 as a power source. The CPLT signal is output to an ECU 350 of power equipment 300 (HEMS 305) and an ECU 150 of vehicle 5.

Oscillation circuit 750 is controlled by C-ECU 710 and outputs a signal having a non-oscillating DC voltage or a signal that oscillates at a prescribed frequency (e.g., 1 kHz) and a prescribed duty cycle.

Furthermore, C-ECU 710 controls ON/OFF of CCID relay 800 in accordance with a change in pilot signal CPLT. Specifically, C-ECU 710 supplies or stops a current to electromagnetic coil 730 in accordance with a recognition state of pilot signal CPLT in control pilot circuit 720. As a result, the electromagnetic force by electromagnetic coil 730 is generated or stopped, and thus, a contact point of CCID relay 800 is controlled to enter the open state (ON) or the connected state (OFF). Leakage detector 740 (ground-fault circuit interrupter (GFCI)) includes an industrial ground-fault circuit interrupter and is configured to interrupt the electric power when detecting a leakage.

Power line 160 is arranged to electrically connect plug 110 and connector 120 via leakage detector 740 and CCID relay 800. CCID relay 800 is inserted into and connected to power line 160. In the non-connected state in which the contact point of CCID relay 800 is open, a conduction path from power equipment 300 to vehicle 5 is interrupted in power cable 100.

On the other hand, when CCID relay 800 enters the connected state, the conduction path from power equipment 300 via power line 160 in power cable 100 is formed. As a result, a charging device mounted on vehicle 5 enters the chargeable state. A voltage of pilot signal CPLT for controlling ON/OFF of CCID relay 800 is changed by ECU 150 of vehicle 5 described below.

Next, the configuration of vehicle 5 will be described.

Vehicle 5 includes a power storage device BAT and a driving power generation device 30 for vehicle running. Power storage device BAT is represented as one example of a rechargeable power storage device, and is typically configured by a secondary battery such as a lithium ion battery and a nickel-metal hydride battery.

Driving power generation device 30 is configured to include, for example, a motor (not shown) for driving the vehicle, an inverter (not shown) for performing bidirectional power conversion (DC/AC) between power storage device BAT and the motor for driving the vehicle, and a driving wheel (not shown) mechanically coupled to an output shaft of the motor for driving the vehicle. Alternatively, driving power generation device 30 may include a generator for charging power storage device BAT, and an engine that can drive the generator. Alternatively, driving power generation device 30 may be configured to cause the vehicle to run while switching among running by using an output of only the engine, running by using an output of only the motor for driving the vehicle, and running by using outputs of both the engine and the motor for driving the vehicle. In either case, in vehicle 5, driving power generation device 30 is configured to have the function of generating the vehicle driving force by using the electric power of power storage device BAT.

As a configuration for external charging of power storage device BAT, vehicle 5 further includes inlet 500, a voltage sensor 10, a power line 11, a charger 20 having the power conversion function, a charging relay CHR, ECU 150, and a signal control circuit 405. Inlet 500 is provided at a body of vehicle 5.

Power line 11 electrically connects inlet 500 and charger 20 in vehicle 5. Voltage sensor 10 detects a voltage on power line 11. A detection value by voltage sensor 10 is transmitted to ECU 150.

Charger 20 converts the electric power transmitted from power equipment 300 to power line 11 via power cable 100 into the charging power (DC power) of power storage device BAT. Charging relay CHR is connected between charger 20 and power storage device BAT, and forms or interrupts a conduction path from charger 20 to power storage device BAT. Charging relay CHR is turned on at the time of external charging, while charging relay CHR is turned off at the time of non-external charging.

Similarly to C-ECU 710, ECU 150 is configured to include a CPU, a storage device, an input/output buffer and the like, all of which are not shown, and executes a control process for controlling the operation of vehicle 5 including external charging.

Furthermore, by using signal control circuit 405, ECU 150 changes the voltage of pilot signal CPLT for controlling ON/OFF of CCID relay 800 in power cable 100. Specifically, ECU 150 can change the voltage of pilot signal CPLT in accordance with a control command SC.

Signal control circuit 405 has a resistance circuit 410. Resistance circuit 410 includes pull-down resistors R1 and R2, and a switch SW2. Pull-down resistor R1 of resistance circuit 410 is connected between a control pilot line L1 on which pilot signal CPLT is communicated and a vehicle ground 420. Pull-down resistor R2 and switch SW2 are serially connected between control pilot line L1 and vehicle ground 420.

ON/OFF of switch SW2 is controlled in accordance with control command SC from ECU 150. When switch SW2 is ON, pull-down resistors R1 and R2 are both connected in parallel, and thus, the voltage of control pilot line L1 (i.e., the voltage of pilot signal CPLT) decreases. In accordance with control command SC, the voltage of pilot signal CPLT is switched between a voltage V1 (e.g., 9 V) and a voltage V2 (e.g., 6 V) lower than voltage V1.

ECU 150 also receives connect signal CNCT from connector 120 of power cable 100 via signal line L2. A power supply node 421 is connected to signal line L2 with a resistor element R4 interposed therebetween.

Based on an event that connection detector 125 is turned on and the voltage of connect signal CNCT decreases (ground voltage), ECU 150 can detect that connector 120 has been connected to inlet 500.

In the configuration shown in FIG. 2, pilot signal CPLT corresponds to one example of “first signal”, and connect signal CNCT corresponds to one example of “second signal”. Therefore, control pilot circuit 720 corresponds to one example of “signal generation circuit”, and signal control circuit 405 corresponds to one example of “signal control circuit”. In addition, inlet 500 corresponds to one example of “electrical contact point” of vehicle 5, and connector 120 corresponds to one example of “connection node”. Charger 20 corresponds to one example of “power converter”.

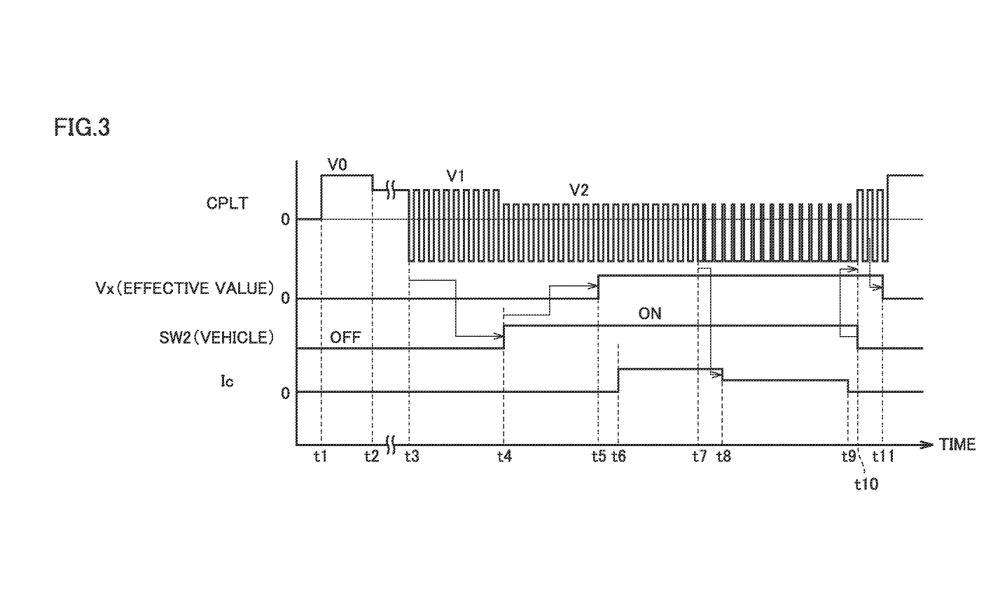

FIG. 3 is a time chart for describing the operation for external charging of the vehicle.

Referring to FIG. 3, until time t1, power cable 100 is connected to none of vehicle 5 and power equipment 300. In this state, switch SW2 and CCID relay 800 are in the non-conduction state in FIG. 2. The voltage of pilot signal CPLT is 0 V. Furthermore, the voltage of connect signal CNCT shown in FIG. 2 is a prescribed voltage Vcn (Vcn>0 V).

At time t1, plug 110 of power cable 100 is connected to electrical outlet 308 of power equipment 300. Then, control pilot circuit 720 receives the electric power from power equipment 300 and generates pilot signal CPLT. As a result, the voltage of the CPLT signal rises to V0.

Next, at time t2, connector 120 is connected to inlet 500. Then, the switch that forms connection detector 125 is turned on, and thus, the voltage of connect signal CNCT in FIG. 2 decreases. Based on this voltage change, ECU 150 of vehicle 5 detects that connector 120 has been connected to inlet 500. At this time, the voltage of pilot signal CPLT decreases to V1 due to pull-down resistor R1.

At time t2, the state in which power cable 100 is electrically connected to power equipment 300 (electrical outlet 308) and vehicle 5 (inlet 500) is formed. As a result, power transmission between power equipment 300 and vehicle 5 via power line 160 becomes possible. When CCID relay 800 is turned on from this state, the electric power from power equipment 300 is actually supplied to vehicle 5 via power line 160.

During a time period between times t1 and t2, plug 110 of power cable 100 is connected to electrical outlet 308, while connector 120 of power cable 100 is not connected to inlet 500. In this state, the voltage of pilot signal CPLT is VO and pilot signal CPLT is in the non-oscillating state.

When connector 120 is connected to inlet 500, while plug 110 is not connected to electrical outlet 308, the electric power is not supplied to control pilot circuit 720, and thus, the voltage of pilot signal CPLT is 0. Namely, the state in which the voltage of pilot signal CPLT decreases to V1 at time t2 appears when power cable 100 is electrically connected to both power equipment 300 (electrical outlet 308) and vehicle 5 (inlet 500).

After the voltage of pilot signal CPLT decreases to V1, C-ECU 710 oscillates pilot signal CPLT by using oscillation circuit 750 at time t3. As a result, after time t3, pilot signal CPLT is oscillated and forms a pulsed waveform. As described below, a prescribed sequence for external charging is triggered by the start of oscillation of pilot signal CPLT at time t3 in FIG. 2.

When detecting that pilot signal CPLT has been oscillated, ECU 150 detects a rated current of power cable 100 based on the duty of pulsed pilot signal CPLT.

At time t4, ECU 150 transmits control command SC and turns on switch SW2 in order to start the charging operation. As a result, the voltage of pilot signal CPLT in FIG. 2 decreases to V2 due to pull-down resistor R2.

At time t5, in response to the detection of the decrease (from V1 to V2) in voltage of pilot signal CPLT at time t4, C-ECU 710 turns on CCID relay 800. As a result, the electric power from power equipment 300 is transmitted to vehicle 5 via power cable 100. Consequently, a voltage Vx of power line 11 of vehicle 5 rises. Namely, a state of being capable of externally charging power storage device BAT becomes ready.

At time t5, when detecting power supply from the external power supply (power equipment 300) in response to an increase in voltage detection value by voltage sensor 10 (FIG. 2), ECU 150 turns on charging relay CHR and starts power conversion by charger 20, and thus, starts charging of power storage device BAT at time t6. As a result, generation of a charging current Ic of power storage device BAT is started.

In the example of FIG. 3, the charging current is changed during external charging, in accordance with the duty of pilot signal CPLT. Specifically, in an early stage of charging until time t7, the charging current is set to be large for quick charging. However, the duty of pilot signal CPLT is decreased after time t7. In response to this, the charging current becomes small at time t8.

After time t8 as well, charging of power storage device BAT proceeds, and at time t9, ECU 150 detects that power storage device BAT has been fully charged. In response to this, at time t10, ECU 150 stops charger 20 and turns off switch SW2 in FIG. 1 in accordance with control command SC, in order to end external charging. In response to the turnoff of switch SW2, the voltage of pilot signal CPLT rises to V1.

In response to the change in voltage of pilot signal CPLT, at time t11, control pilot circuit 720 turns off CCID relay 800 of CCID 700. As a result, the power supply from the external power supply (power equipment 300) to vehicle 5 via power cable 100 is interrupted. Therefore, after time t11, voltage Vx of power line 11 of vehicle 5 detected by voltage sensor 10 becomes zero.

As described above, vehicle 5 is configured to perform external charging of the power storage device mounted on vehicle 5 in accordance with the prescribed sequence triggered by the start of oscillation of pilot signal CPLT (time t3), with power cable 100 being electrically connected to both the external power supply and vehicle 5.

In the case of so-called timer charging in which the start timing of external charging is specified by time, a control command is issued from power equipment 300 (ECU 350) or vehicle 5 (ECU 150) such that control pilot circuit 720 awaits oscillation of pilot signal CPLT, until the charging start time comes.

Generally, in the case of time-based timer charging, the time that specifies by when external charging of vehicle 5 should be ended, or the estimated departure time of vehicle 5 is input. A charging schedule including the charging start time is formulated such that external charging ends by the aforementioned time. As a result, the charging start time is set in accordance with the time specified by the user, with consideration given to the time required to reach the fully-charged state which changes depending on the current SOC (State of Charge) of power storage device BAT, the electricity rate in each time period, and a duration from the fully-charged state to the start of electric power usage. At this time, depending on the circumstances, there may be a case in which external charging must be started immediately after connection of power cable 100.

Alternatively, even when the specified time is not input by the user and external charging is started immediately after connection of power cable 100, the start of external charging can be controlled in accordance with the control process common to that of timer charging, by setting, as the charging start time, the time immediately after connection of power cable 100 is established. As a result, it is unnecessary to switch the control process in accordance with whether or not the time is specified by the user, and thus, the control process can be simplified.

In the present embodiment, the control process for executing time-based external charging that involves setting of the charging start time will be described below.

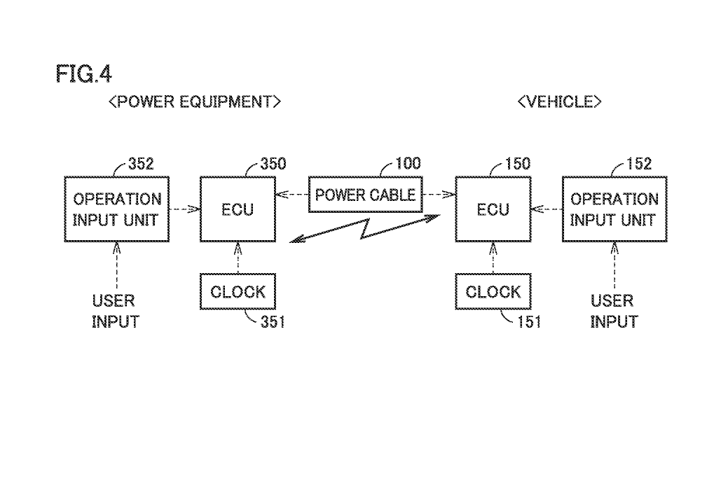

FIG. 4 is a block diagram for describing reception and transmission of information between vehicle 5 and power equipment 300 in the power system according to the present embodiment.

Referring to FIG. 4, ECU 350, a clock 351, and an operation input unit 352 are arranged in power equipment 300. Similarly to C-ECU 710 and ECU 150, ECU 350 is configured to include a CPU, a storage device, an input/output buffer and the like, all of which are not shown. For example, ECU 350 executes the aforementioned control operation by HEMS 305.

Clock 351 is provided for ECU 350 to detect the current time. Operation input unit 352 is configured to accept an input instruction by the user. The aforementioned specified time about external charging is, for example, input to operation input unit 352. This specified time may directly specify the charging start time, or may specify the time that is a time limit for ending external charging (the estimated departure time of vehicle 5).

On the other hand, ECU 150, a clock 151 and an operation input unit 152 are arranged in vehicle 5. Clock 151 is provided for ECU 150 to detect the current time. Similarly to operation input unit 352, the specified time about external charging can be input to operation input unit 152. Clocks 151 and 351 can be configured by an arbitrary element that can detect the current time, and can also be configured as an internal function of each ECU.

As described above, information and data can be received and transmitted between ECU 350 and ECU 150 by power line communication via power cable 100 or wireless communication.

In the configuration shown in FIG. 4, ECU 150 corresponds to “first control device” or “control device”, and ECU 350 corresponds to “second control device” or “control device”. Clock 151 corresponds to “first clock” or “clock”, and clock 351 corresponds to “second clock” or “clock”.

As compared with clock 351 of power equipment 300, a time error tends to easily occur in clock 151 mounted on vehicle 5, due to vibrations during running and exposure to the external air. As a result, a time lag in the current time occurs between clock 151 and clock 351, and thus, a time lag occurs between the current time recognized by power equipment 300 and the current time recognized by vehicle 5.

At this time, in the case of external charging started on a time basis that involves setting of the charging start time, it is concerned that the charging operation cannot be started due to this time lag. For example, in the case where a time period from connection of power cable 100 to the start of charging is short, there is a possibility that when the time immediately after connection of power cable 100 is set as the charging start time in power equipment 300 (HEMS 305), this charging start time has already gone by in clock 151 of vehicle 5 due to an influence of the time lag.

As a result, the charging operation in vehicle 5 is not started until the charging start time on the following day comes, and thus, it is concerned that reliable execution of external charging in accordance with the user's request becomes difficult.

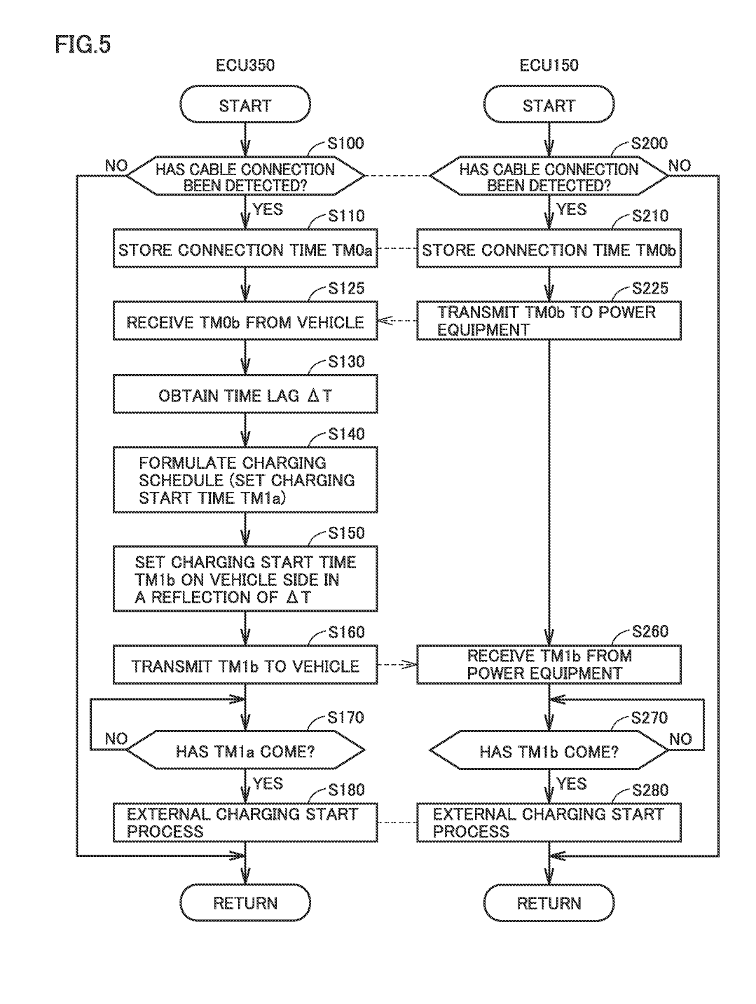

Therefore, in the first embodiment, description will be given to the control process for reliably starting external charging at the set charging start time in accordance with a time synchronization process triggered by establishment of connection of power cable 100. FIGS. 5 to 8 show examples of the control process for external charging in the power system according to the first embodiment. As shown in FIGS. 5 to 8, ECU 350 of power equipment 300 and ECU 150 of vehicle 5 operate cooperatively, and thus, vehicle 5 is externally charged.

FIG. 5 is a flowchart describing a first example of the control process for external charging in the power system according to the first embodiment.

Referring to FIG. 5, in step S100, ECU 350 determines whether or not connection of power cable 100 has been detected. Similarly, in step S200, ECU 150 determines whether or not connection of power cable 100 has been detected.

As described above, establishment of connection of power cable 100 can be detected at the same timing in both ECU 150 and ECU 350, based on the decrease in voltage of the CPLT signal.

If connection of power cable 100 is not detected (NO in S100 and S200), ECU 350 does not start the control process in and after step S110 and the control process in and after step S210. Namely, the control process for starting external charging according to the first embodiment is triggered by the detection of connection of power cable 100.

If connection of power cable 100 is detected (YES in S100), ECU 350 moves the process to step S110 and stores a connection time TM0a on the power equipment side, based on a current time output by clock 351.

Similarly, if connection of power cable 100 is detected (YES in S100), in step S210, ECU 150 stores a connection time TM0b on the vehicle side, based on a current time output by clock 151.

Connection times TM0a and TM0b correspond to the current times detected by clock 351 and clock 151 at the same timing, respectively, and thus, a time difference that reflects a time lag between clock 351 and clock 151 occurs between connection times TM0a and TM0b.

In the example of FIG. 5, in step S225, ECU 150 transmits connection time TM0b to power equipment 300. In response to this, in step S125, ECU 350 receives connection time TM0b from vehicle 5.

Furthermore, in step S130, ECU 350 obtains a time lag ΔT between connection time TM0a on the power equipment side and connection time TM0b on the vehicle side.

In the example of FIG. 5, in step S140, ECU 350 formulates an external charging schedule. As described above, the charging schedule is formulated to reflect the time specified by the user, the current SOC of power storage device BAT, and the like. When the charging schedule is formulated, a charging start time TM1a is set on the power equipment side, based on the current time detected by clock 351.

In step S150, based on charging start time TM1a on the power equipment side, ECU 350 sets a charging start time TM1b on the vehicle side that reflects time lag ΔT obtained in step S130. Namely, a time difference corresponding to time lag ΔT is provided between charging start time TM1b and charging start time TM1a. For example, when clock 351 is 10 minutes ahead of clock 151, charging start time TM1b is set to be 10 minutes behind of charging start time TM1a.

Furthermore, in step S160, ECU 350 transmits charging start time TM1b set in step S150 to vehicle 5. In response to this, in step S260, ECU 150 receives charging start time TM1b on the vehicle side transmitted from ECU 350. At this point of time, charging start times TM1a and TM1b that are equivalently synchronized due to reflection of time lag ΔT are set in vehicle 5 and power equipment 300.

In step S170, ECU 350 determines whether or not charging start time TM1a on the power equipment side set in step S140 has come, based on the current time detected by clock 351. If charging start time TM1a has come (YES in S170), ECU 350 moves the process to step S180 and performs the process for starting external charging.

On the other hand, in step S270, ECU 150 determines whether or not charging start time TM1b on the vehicle side received in step S260 has come, based on the current time detected by clock 151. If charging start time TM1b has come (YES in S270), ECU 150 moves the process to step S280 and performs the process for starting external charging.

For example, in step S180 or S280, the control command is issued to control pilot circuit 720 to start oscillation of pilot signal CPLT as described with reference to FIG. 3. As a result, the process at and after time t3 described with reference to FIG. 3 is executed sequentially. In addition, in step S280, control of power distribution board 302 for supplying the electric power to vehicle 5 is executed.

Consequently, the processes for starting external charging in steps S180 and S280 are executed synchronously. As a result, control for external charging in each of power equipment 300 and vehicle 5 can be triggered by the start of oscillation of pilot signal CPLT shown in FIG. 3.

Therefore, even when there is a time lag between the clock of power equipment 300 and the clock of vehicle 5, external charging can be reliably started at the set charging start times in accordance with the common time schedule.

In the example of FIG. 5, description has been given to the example in which formulation of the charging schedule and obtainment of time lag ΔT are executed on the power equipment side (ECU 350). However, these two functions may be executed on the power equipment side (ECU 350) or on the vehicle side (ECU 150).

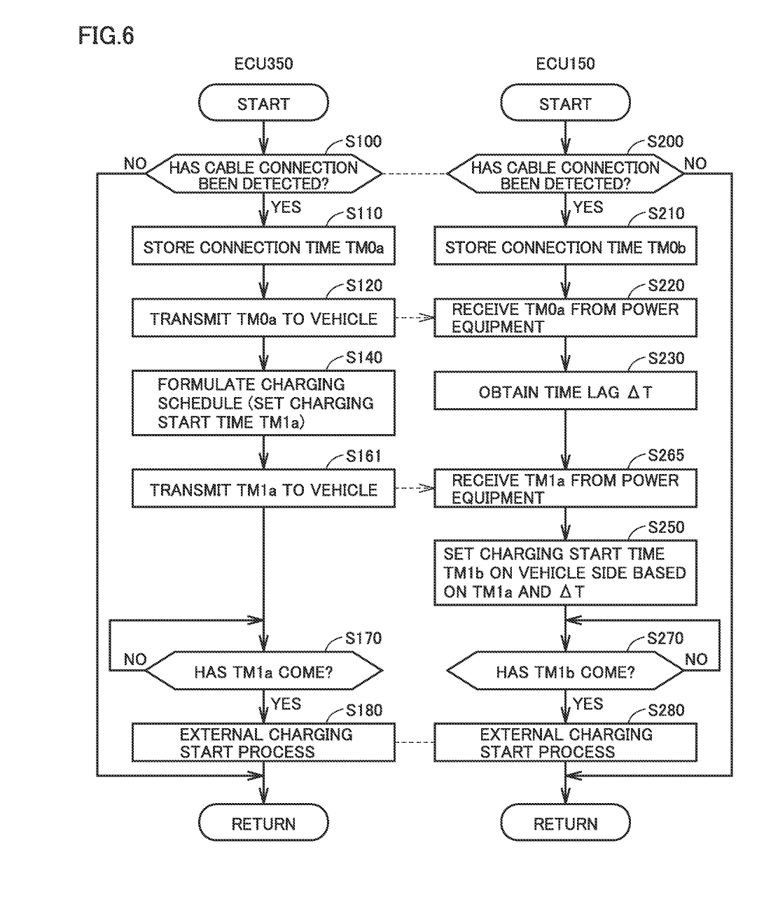

For example, as shown in FIG. 6, a control process for moving the function of obtaining time lag ΔT to the vehicle side is also possible.

FIG. 6 is a flowchart describing a second example of the control process for external charging in the power system according to the first embodiment.

Referring to FIG. 6, steps S100 and S110 as well as steps S200 and S210 similar to those in FIG. 5 are executed by ECU 350 and ECU 150. As a result, in response to establishment of connection of power cable 100, connection times TMa and TM0b are stored on the power equipment side and on the vehicle side, respectively.

In the example of FIG. 6, in step S120, ECU 350 transmits connection time TM0a in power equipment 300 to ECU 150 of vehicle 5. In step S220, ECU 150 receives connection time TM0a on the power equipment side. Then, ECU 150 moves the process to step S230 and obtains time lag ΔT between connection times TM0b and TM0a.

In step S140 similar to that in FIG. 5, ECU 350 formulates the charging schedule. As a result, charging start time TM1a based on the current time detected by clock 351 is determined on the power equipment side. Furthermore, in step S161, ECU 350 transmits charging start time TM1a set in step S140 to vehicle 5.

In step S265, ECU 150 receives charging start time TM1a on the power equipment side. Furthermore, in step S250, based on charging start time TM1a on the power equipment side, ECU 150 sets charging start time TM1b on the vehicle side that reflects time lag ΔT obtained in step S230.

As a result, similarly to the example of FIG. 5, charging start times TM1a and TM1b that are equivalently synchronized due to reflection of time lag ΔT can be set in vehicle 5 and power equipment 300.

In the control example of FIG. 6 as well, the process in and after step S170 and the process in and after step S270 after setting charging start times TM1a and TM1b are similar to those in FIG. 5, and thus, detailed description will not be repeated. Therefore, similarly to the control example of FIG. 5, external charging can be reliably started at the set charging start times in accordance with the common time schedule.

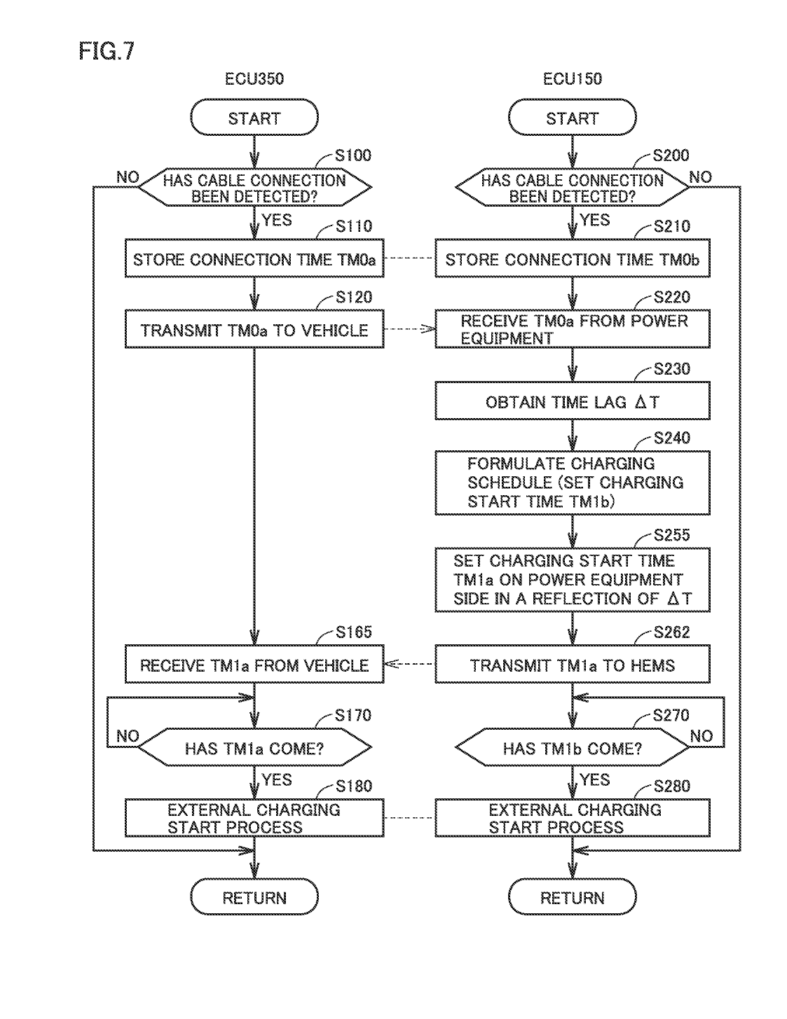

FIG. 7 is a flowchart describing a third example of the control process for external charging in the power system according to the first embodiment. In the control process example of FIG. 7, obtainment of time lag ΔT and formulation of the charging schedule are both executed by ECU 150 of vehicle 5.

Referring to FIG. 7, in steps S100 and S110 as well as steps S200 and S210 similar to those in FIGS. 5 and 6, ECU 350 and ECU 150 store connection times TM0a and TM0b on the power equipment side and on the vehicle side, respectively, in response to establishment of connection of power cable 100.

In the control example of FIG. 7, in step S120 similar to that in FIG. 6, ECU 350 transmits connection time TM0a to vehicle 5. In steps S220 and S230 similar to those in FIG. 6, ECU 150 receives connection time TM0a on the power equipment side and obtains time lag ΔT between connection times TM0b and TM0a.

Furthermore, in step S240, ECU 150 formulates the charging schedule similarly to step S140 in FIG. 5. In step S240, charging start time TM1b on the vehicle side is set based on the current time detected by clock 151.

In step S255, based on charging start time TM1b on the vehicle side, ECU 150 sets charging start time TM1a on the power equipment side that reflects time lag ΔT obtained in step S230. Here as well, a time difference corresponding to time lag ΔT is provided between charging start time TM1b and charging start time TM1a.

Furthermore, in step S262, ECU 150 transmits charging start time TM1a set in step S250 to power equipment 300. In response to this, in step S165, ECU 350 receives charging start time TM1a on the power equipment side transmitted from ECU 150.

Therefore, similarly to the examples of FIGS. 5 and 6, before execution of steps S170 and S270, charging start times TM1a and TM1b that are equivalently synchronized due to reflection of time lag ΔT are set in vehicle 5 and power equipment 300. Since the process in and after step S170 and the process in and after step S270 after setting charging start times TM1a and TM1b are similar to those in FIGS. 5 and 6, detailed description will not be repeated.

As a result, similarly to the control examples of FIGS. 5 and 6, external charging can be reliably started at the set charging start times in accordance with the common time schedule.

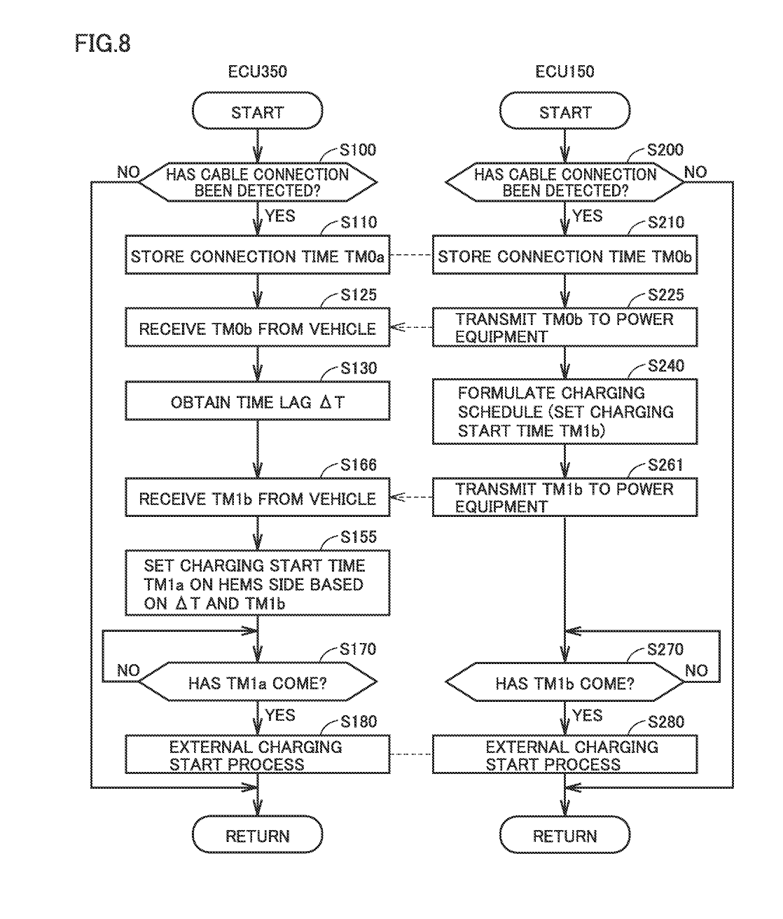

FIG. 8 shows a flowchart describing a fourth example of the control process for external charging in the power system according to the first embodiment. In the control process example of FIG. 8, the charging schedule is formulated by ECU 150 of vehicle 5, while the time lag is obtained by ECU 150 of power equipment 300.

Referring to FIG. 8, in steps S100 and S110 as well as steps S200 and S210 similar to those in FIGS. 5 to 7, ECU 350 and ECU 150 store connection times TM0a and TM0b on the power equipment side and on the vehicle side, respectively, in response to establishment of connection of power cable 100.

In step S225 similar to that in FIG. 5, ECU 150 transmits connection time TM0b on the vehicle side to power equipment 300 (HEMS 305). In response to this, in step S125, ECU 350 receives connection time TM0b from vehicle 5. Furthermore, in step S130 similar to that in FIG. 5, ECU 350 obtains time lag ΔT between connection time TM0a on the power equipment side and connection time TM0b on the vehicle side.

In step S240 similar to that in FIG. 7, ECU 150 formulates the charging schedule, and sets charging start time TM1b on the vehicle side based on the current time detected by clock 151. Furthermore, in step S261, ECU 150 transmits charging start time TM1b set in step S240 to power equipment 300. In response to this, in step S166, ECU 350 receives charging start time TM1b on the vehicle side transmitted from ECU 150.

In step S155, based on received charging start time TM1b on the vehicle side, ECU 350 sets charging start time TM1a on the power equipment side that reflects time lag ΔT obtained in step S130.

As a result, similarly to the examples of FIGS. 5 to 7, before execution of steps S170 and S270, charging start times TM1a and TM1b that are equivalently synchronized due to reflection of time lag ΔT are set in vehicle 5 and power equipment 300. Since the process in and after step S170 and the process in and after step S270 after setting charging start times TM1a and TM1b are similar to those in FIGS. 5 to 7, detailed description will not be repeated.

As described above, in any of the examples of FIGS. 5 to 8, in response to the detection of establishment of connection of power cable 100, time lag ΔT between the clock on the vehicle side and the clock on the power equipment side can be obtained by both ECU 150 and ECU 350. Furthermore, regardless of whether ECU 150 or ECU 350 formulates the charging schedule, the time difference corresponding to time lag ΔT can be provided between the charging start time on the vehicle side and the charging start time on the power equipment side. As a result, ECU 150 and ECU 350 can synchronously detect that the charging start times have come, based on the current time detected by clock 151 in ECU 150 and based on the current time detected by clock 351 in ECU 350.

As described above, in the power system including the vehicle and the power equipment according to the first embodiment, even when there is a time lag between the clock of the vehicle and the clock of the power equipment, the charging start times that are equivalently synchronized due to reflection of the time lag can be set in the vehicle and the power equipment. As a result, external charging of the vehicle can be reliably executed in accordance with the charging schedule common to the power equipment and the vehicle.

As shown in FIGS. 5 to 8 for illustrative purpose, charging start time TM1a on the power equipment side may be obtained by calculation by ECU 350, or may be obtained by reception from ECU 150. Similarly, charging start time TM1b on the vehicle side may be obtained by calculation by ECU 150, or may be obtained by reception from ECU 350.

### Second Embodiment

In the first embodiment, external charging of vehicle 5 by power transmission from power equipment 300 to vehicle 5 has been described. In contrast, vehicle 5 can also convert the electric power of power storage device BAT into AC power equivalent to that of system power supply 400, and supply the AC power to power equipment 300. In the following description, power feeding from vehicle 5 to power equipment 300 will also be referred to as “external power feeding”.

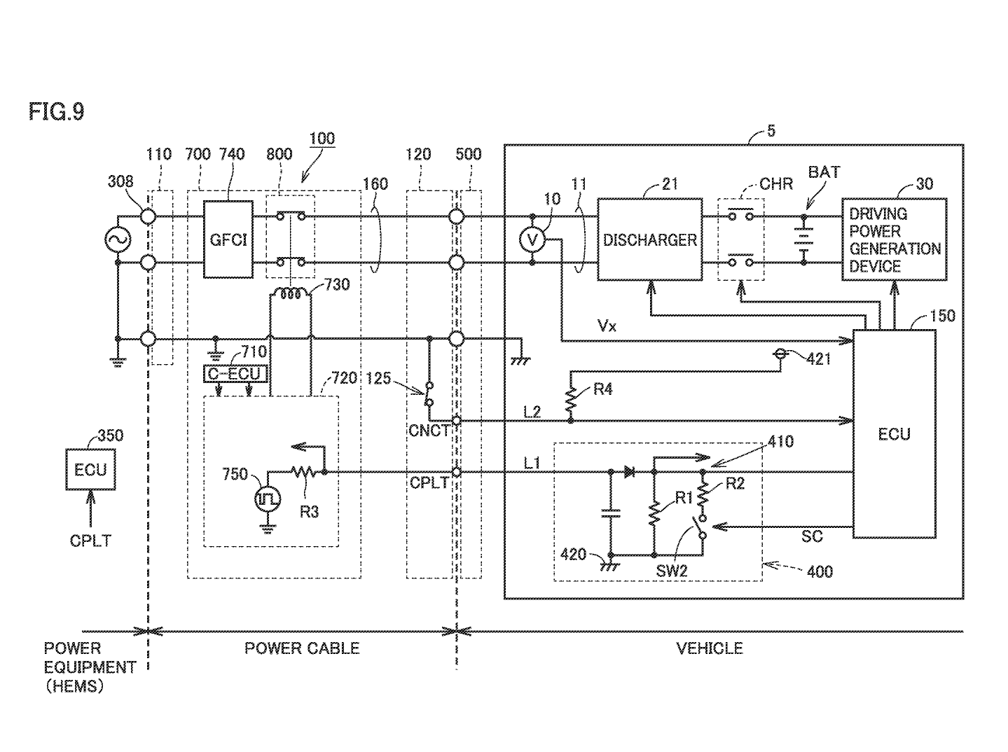

FIG. 9 is a block diagram for describing a configuration of a vehicle in a power system according to a second embodiment.

FIG. 9 is different from FIG. 2 in that in the second embodiment, a discharger 21 is arranged in vehicle 5 instead of charger 20. Since the configuration of the remaining portions of vehicle 5 is similar to that in FIG. 2, detailed description will not be repeated.

Discharger 21 converts the discharging power (DC power) from power storage device BAT into AC power equivalent to that of system power supply 400. Discharger 21 outputs the converted AC power to power line 11. In the configuration shown in FIG. 9, discharger 21 corresponds to one example of “power converter”.

Vehicle 5 shown in FIG. 9 can execute the power feeding operation for supplying an output voltage of discharger 21 to the outside of the vehicle (typically, power equipment 300) via power cable 100.

Similarly to external charging, vehicle 5 and power equipment 300 can be electrically connected by power cable 100 during external power feeding as well. Namely, external power feeding can be executed by power conversion in the direction opposite to the direction of external charging described with reference to FIG. 2. In a hybrid vehicle in which an engine (not shown) is provided in driving power generation device 30, the electric power generated by an engine output is converted into the charging power of power storage device BAT. Therefore, during external power feeding as well, the AC power for external power feeding can also be generated by using the electric power generated by the engine output as a source.

External power feeding can also be performed on a time basis. For example, a discharging start time can be set such that a cost advantage is obtained by externally charging vehicle 5 using the inexpensive night-time electric power, and thereafter, making up for at least a part of the electric power consumed in house 301 during the daytime by external power feeding. For example, the discharging start time can also be set in accordance with the inputs to operation input units 152 and 352 (FIG. 4) from the user. Alternatively, when permission of external power feeding is input from the user, the discharging start time can also be automatically set to specify a time period associated with the electricity rate.

Connection by power cable 100 is necessary during external power feeding as well. Therefore, similarly to external charging, there is a possibility that when the time immediately after connection of power cable 100 is set as a power feeding start time, external power feeding cannot be executed in accordance with the user's request, due to an influence of a time lag between clock 151 of vehicle 5 and clock 351 of power equipment 300.

Therefore, it is preferable to execute a control process for external power feeding similarly to the control process for external charging described in the first embodiment.

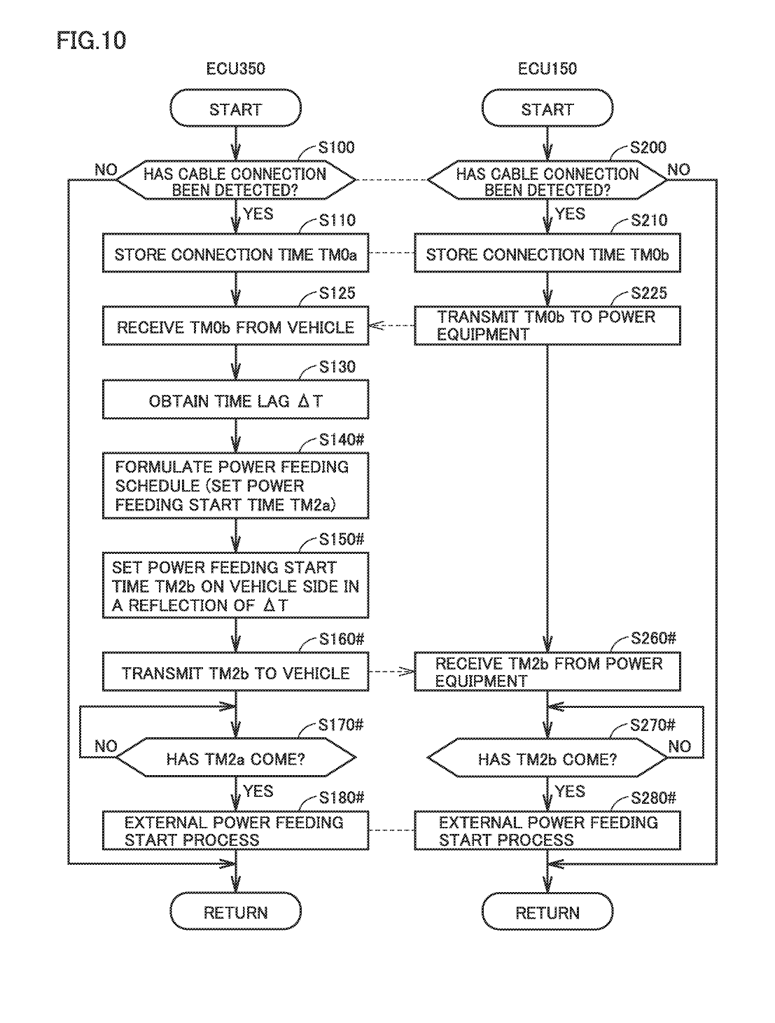

FIGS. 10 to 13 show flowcharts describing the control process for external power feeding in the power system according to the second embodiment. As shown in FIGS. 10 to 13, external power feeding from vehicle 5 is also executed by the cooperative operation of ECU 350 of power equipment 300 and ECU 150 of vehicle 5.

FIG. 10 is a flowchart describing a first example of the control process for external power feeding in the power system according to the second embodiment. In the example of FIG. 10, formulation of a power feeding schedule and obtainment of time lag ΔT are executed on the power equipment side (ECU 350).

Comparing FIG. 10 with FIG. 5, ECU 350 executes steps S140# to S180#, instead of steps S140 to S180, after execution of steps S100 to S130 similar to those in FIG. 5. In step S140#, ECU 350 formulates the power feeding schedule, and sets a power feeding start time TM2a based on the current time detected by clock 351. Then, in step S150#, a power feeding start time TM2b on the vehicle side that reflects time lag ΔT obtained in step S130 is set based on power feeding start time TM2a on the power equipment side.

Furthermore, in step S160#, ECU 350 transmits power feeding start time TM2b set in step S150# to vehicle 5. Furthermore, in step S170#, ECU 350 determines whether or not power feeding start time TM2a on the power equipment side set in step S140# has come, based on the current time detected by clock 351. If power feeding start time TM2a has come (YES in S170#), ECU 350 moves the process to step S180# and performs the process for starting external power feeding.

On the other hand, ECU 150 executes steps S260# to S280#, instead of steps S260 to S280, after execution of steps S200, S210 and S225 similar to those in FIG. 5. In step S260#, ECU 150 receives power feeding start time TM2b on the vehicle side transmitted from ECU 350. Furthermore, in step S270#, ECU 150 determines whether or not power feeding start time TM2b on the vehicle side has come, based on the current time detected by clock 151. If power feeding start time TM2b has come (YES in S270#), ECU 350 moves the process to step S280# and performs the process for starting external power feeding.

For example, in step S180# or S280#, the control command is issued to control pilot circuit 720 to start oscillation of pilot signal CPLT as described with reference to FIG. 3. As a result, CCID relay 800 in power cable 100 is turned on, and thus, the power transmission path is formed between vehicle 5 and power equipment 300. Furthermore, in step S180#, a relay CHR is turned on and actuation of discharger 21 is started. In step S280#, control of power distribution board 302 for receiving the electric power from vehicle 5 is executed.

Consequently, before execution of steps S170# and S270#, power feeding start times TM2a and TM2b that are equivalently synchronized due to reflection of time lag ΔT can be set. As a result, the processes for starting external power feeding in steps S180# and S280# are synchronously executed. Therefore, even when there is a time lag between the clock of power equipment 300 and the clock of vehicle 5, external power feeding can be reliably started at the set power feeding start times in accordance with the common time schedule.

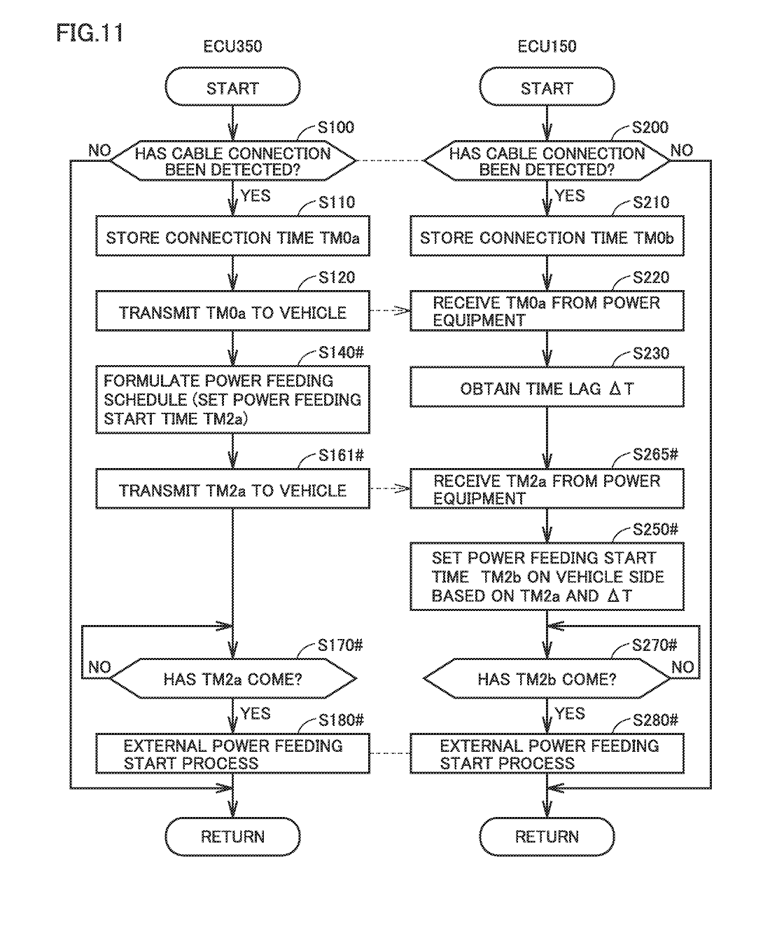

FIG. 11 is a flowchart describing a second example of the control process for external power feeding in the power system according to the second embodiment. In the example of FIG. 11, formulation of the power feeding schedule is executed on the power equipment side (ECU 350), while obtainment of time lag ΔT is executed on the vehicle side (ECU 150).

Referring to FIG. 11, by the control process (S100 to S120 and S200 to S230) similar to that in FIG. 6, in response to establishment of connection of power cable 100, ECU 350 and ECU 150 store connection times TM0a and TM0b on the power equipment side and on the vehicle side, respectively, and obtain time lag ΔT between connection times TM0a and TM0b.

In step S140# similar to that in FIG. 10, ECU 350 formulates the power feeding schedule. As a result, power feeding start time TM2a based on the current time detected by clock 351 is determined on the power equipment side. Furthermore, in step S161#, ECU 350 transmits power feeding start time TM2a set in step S140# to vehicle 5.

In step S265#, ECU 150 receives power feeding start time TM2a on the power equipment side. Furthermore, in step S250#, based on power feeding start time TM2a on the power equipment side, ECU 150 sets power feeding start time TM2b on the vehicle side that reflects time lag ΔT obtained in step S230.

As a result, similarly to the example of FIG. 10, power feeding start times TM2a and TM2b that are equivalently synchronized due to reflection of time lag ΔT can be set in vehicle 5 and power equipment 300. Since the process in and after step S170# and the process in and after step S270# after setting power feeding start times TM2a and TM2b are similar to those in FIG. 10, detailed description will not be repeated.

As a result, similarly to the control example of FIG. 10, external power feeding can be reliably started at the set power feeding start times in accordance with the common time schedule.

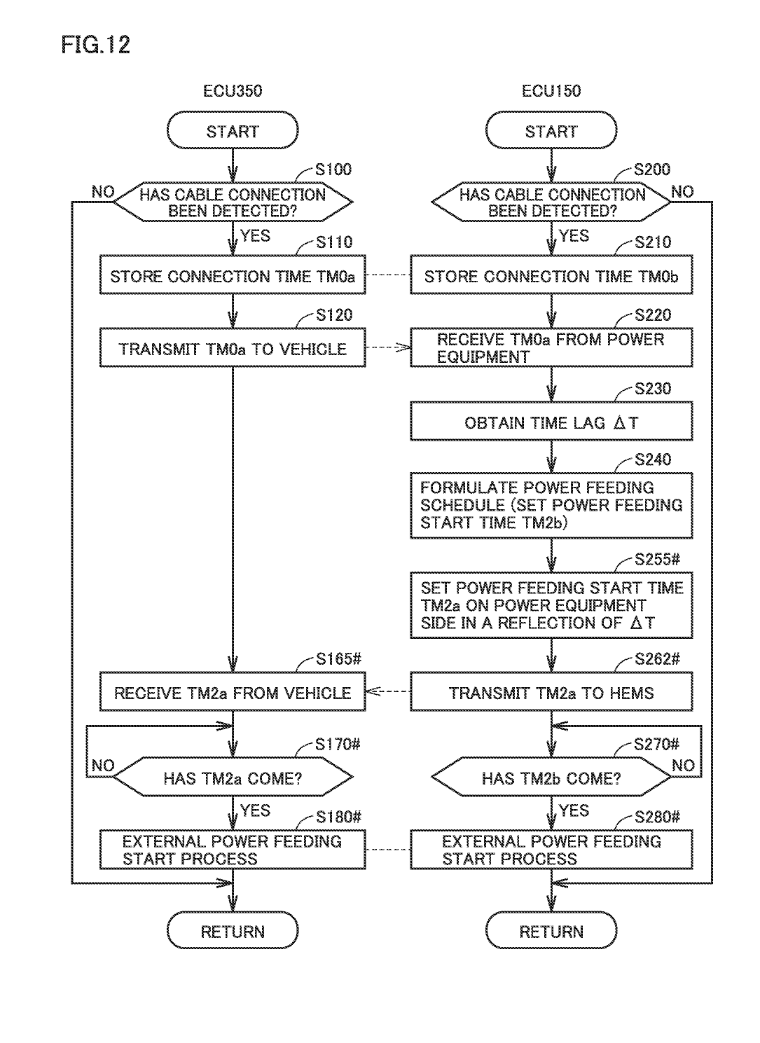

FIG. 12 is a flowchart describing a third example of the control process for external power feeding in the power system according to the second embodiment. In the control process example of FIG. 12, obtainment of time lag ΔT and formulation of the power feeding schedule are both executed by ECU 150 on the vehicle side.

Referring to FIG. 12, in steps S100 to S120 and S200 to S230 similar to those in FIG. 7, in response to establishment of connection of power cable 100, ECU 350 and ECU 150 store connection times TM0a and TM0b on the power equipment side and on the vehicle side, respectively, and obtain time lag ΔT between connection times TM0a and TM0b.

Furthermore, in step S240#, ECU 150 formulates the power feeding schedule, similarly to step S140# in FIG. 10. In step S240#, power feeding start time TM2b on the vehicle side is set based on the current time detected by clock 151.

In step S255#, based on power feeding start time TM2b on the vehicle side, ECU 150 sets power feeding start time TM2a on the power equipment side that reflects time lag ΔT obtained in step S230. Here as well, a time difference corresponding to time lag ΔT is provided between power feeding start time TM2b and power feeding start time TM2a.

Furthermore, in step S262#, ECU 150 transmits power feeding start time TM2a set in step S250# to power equipment 300. In response to this, in step S165#, ECU 350 receives power feeding start time TM2a on the power equipment side.

Therefore, similarly to the examples of FIGS. 10 and 11, before execution of steps S170 and S270, power feeding start times TM2a and TM2b that are equivalently synchronized due to reflection of time lag ΔT are set in vehicle 5 and power equipment 300. Since the process in and after step S170# and the process in and after step S270# after setting power feeding start times TM2a and TM2b are similar to those in FIGS. 10 and 11, detailed description will not be repeated.

As a result, similarly to the control examples of FIGS. 10 and 11, external power feeding can be reliably started at the set power feeding start times in accordance with the common time schedule.

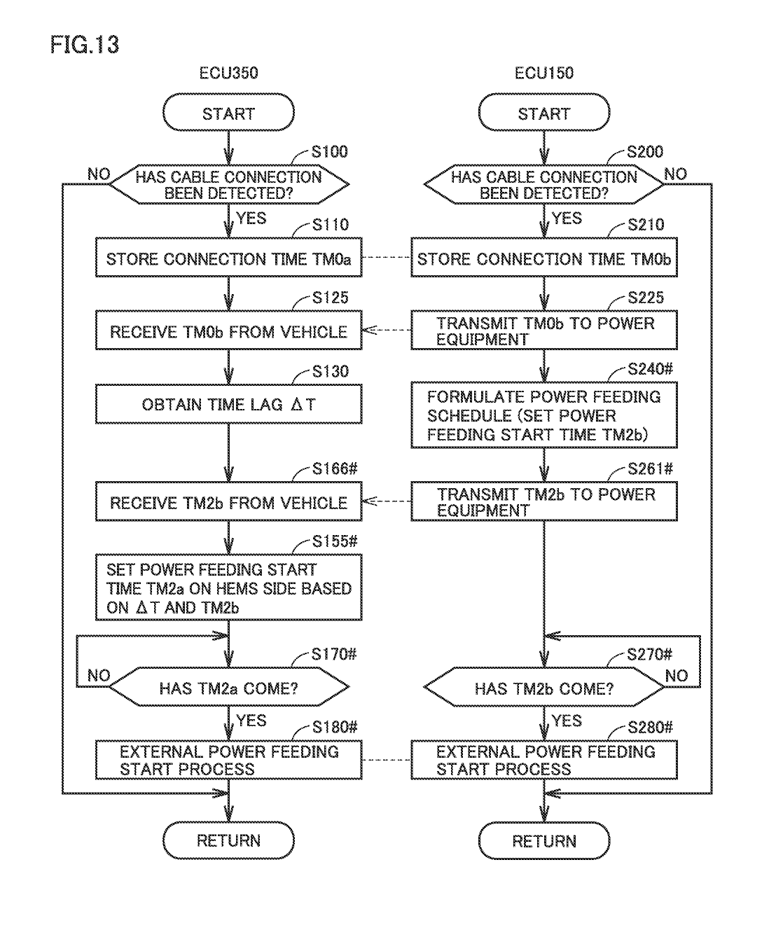

FIG. 13 shows a flowchart describing a fourth example of the control process for external power feeding in the power system according to the second embodiment. In the control process example of FIG. 13, the power feeding schedule is formulated by ECU 150 of vehicle 5, while the time lag is obtained by ECU 350 of power equipment 300.

Referring to FIG. 13, by the control process (S100 to S130 and S200 to S225) similar to that in FIG. 8, in response to establishment of connection of power cable 100, ECU 350 and ECU 150 store connection times TM0a and TM0b on the power equipment side and on the vehicle side, respectively, and obtain time lag ΔT between connection times TM0a and TM0b.

In step S240# similar to that in FIG. 12, ECU 150 formulates the power feeding schedule. As a result, power feeding start time TM2b on the vehicle side is set based on the current time detected by clock 151. Furthermore, in step S261#, ECU 150 transmits power feeding start time TM2b set in step S240# to power equipment 300. In response to this, in step S166#, ECU 350 receives power feeding start time TM2b on the vehicle side transmitted from ECU 150.

In step S155#, based on received power feeding start time TM2b on the vehicle side, ECU 350 sets power feeding start time TM2a on the power equipment side that reflects time lag ΔT obtained in step S130.

As a result, similarly to the examples of FIGS. 10 to 12, before execution of steps S170# and S270#, power feeding start times TM2a and TM2b that are equivalently synchronized due to reflection of time lag ΔT are set in vehicle 5 and power equipment 300. Since the process in and after step S170# and the process in and after step S270# after setting power feeding start times TM2a and TM2b are similar to those in FIGS. 10 to 12, detailed description will not be repeated.

As described above, in any of the examples of FIGS. 10 to 13, in response to the detection of establishment of connection of power cable 100, time lag ΔT between the clock on the vehicle side and the clock on the power equipment side can be obtained by both ECU 150 and ECU 350. Furthermore, regardless of whether ECU 150 or ECU 350 formulates the power feeding schedule, the time difference corresponding to time lag ΔT can be provided between the power feeding start time on the vehicle side and the power feeding start time on the power equipment side. As a result, ECU 150 and ECU 350 can synchronously detect that the power feeding start times have come, based on the current time detected by clock 151 in ECU 150 and based on the current time detected by clock 351 in ECU 350.

As described above, in the power system including the vehicle and the power equipment according to the second embodiment, even when there is a time lag between the clock of the vehicle and the clock of the power equipment, the power feeding start times that are equivalently synchronized due to reflection of the time lag can be set in the vehicle and the power equipment. As a result, external power feeding from the vehicle can be reliably executed in accordance with the power feeding schedule common to the power equipment and the vehicle.

As shown in FIGS. 10 to 13 for illustrative purpose, power feeding start time TM2a on the power equipment side may be obtained by calculation by ECU 350, or may be obtained by reception from ECU 150. Similarly, power feeding start time TM2b on the vehicle side may be obtained by calculation by ECU 150, or may be obtained by reception from ECU 350.

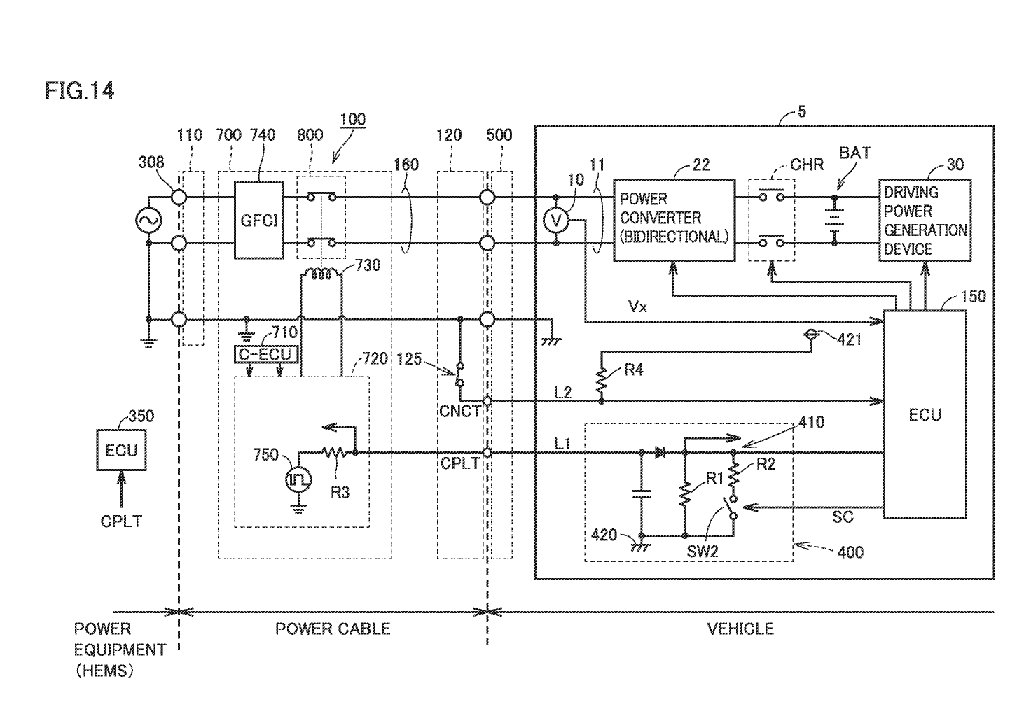

Like a modification shown in FIG. 14, vehicle 5 can also deal with both external charging and external power feeding.

Referring to FIG. 14, a power converter 22 may be arranged in vehicle 5, instead of charger 20 and discharger 21. Power converter 22 is a bidirectional power converter having both the function of charger 20 (AC/DC conversion) and the function of discharger 21 (DC/AC conversion). Alternatively, the function equivalent to that of power converter 22 can also be ensured by parallel arrangement of charger 20 and discharger 21.

With such a configuration, vehicle 5 can execute both external charging and external power feeding. However, external charging and external power feeding cannot be executed at the same time. Therefore, one of external charging and external power feeding can be selectively executed, with vehicle 5 and power equipment 300 being electrically connected. In this case as well, each of external charging and external power feeding can be executed on a time basis that specifies the start time.

As to external charging on a time basis in which the charging start time is set, the control process described with reference to FIGS. 5 to 8 is applied, and thereby, external charging of the vehicle can be reliably executed in accordance with the common charging schedule, even when there is a time lag between the clock of the vehicle and the clock of the power equipment. As to external power feeding on a time basis in which the power feeding start time is set, the control process described with reference to FIGS. 10 to 13 is applied, and thereby, external power feeding from the vehicle can be reliably started in accordance with the common power feeding schedule, even when there is a time lag between the clock of the vehicle and the clock of the power equipment.

As described above, the present invention is applicable to the configuration in which at least one of external charging of the vehicle and external power feeding from the vehicle is executed between the vehicle and the power equipment. Namely, “power converter” mounted on the vehicle is configured to execute at least one of AC/DC conversion by charger 20 (FIG. 2) and DC/AC conversion by discharger 21 (FIG. 9).

In a vehicle having both the function of external charging and the function of external power feeding, it is also possible to separately configure a connection member used during external charging and a connection member used during external power feeding. Namely, the present invention is also applicable to a standard in which a charging cable designed specifically for charging and a power feeding cable designed specifically for power feeding are used in a switchable manner.

In addition, in the present embodiment, the power equipment arranged in a house, a building, a factory or the like has been described for illustrative purpose. However, “power equipment” can also be configured by a charging station or the like that specializes in power transmission between the power equipment and the vehicle.

Particularly, in the present embodiment, description has been given to the configuration example in which power cable 100 forming the connection member is removable from each of power equipment 300 and vehicle 5. However, power equipment 300 and power cable 100 (connection member) may be fixedly connected. In this case, when power cable 100 (connection member) is connected to inlet 500 of vehicle 5, electrical connection between the vehicle and the power equipment is established.

Furthermore, the configuration for detecting the timing of establishment of electrical connection between the vehicle and the power equipment by the power cable (connection member) is not limited to the one described for illustrative purpose in the present embodiment. Namely, the configuration for electrically connecting the vehicle and the power equipment is assumed to be different depending on charging standards and the like. In this case as well, as long as a signal or information indicating establishment of electrical connection between the vehicle and the power equipment is commonly transmitted to the vehicle and the power equipment, the time lag between the current time on the vehicle side and the current time on the power equipment side can be obtained in accordance with this signal or information, and thus, the vehicle and the power equipment can synchronously detect that the charging start time and/or the discharging start time have come, similarly to the present embodiment.

Although the present invention has been described and illustrated in detail, it is clearly understood that the same is by way of illustration and example only and is not to be taken by way of limitation, the scope of the present invention being interpreted by the terms of the appended claims.

What is claimed is:

1. A power system comprising:
a vehicle having a power storage device mounted thereon;
power equipment placed external to the vehicle; and
a connection member that electrically connects the power equipment and the vehicle,
the vehicle including:
a power converter configured to execute at least one of first power conversion and second power conversion, in the first power conversion electric power supplied from the power equipment being converted into charging power of the power storage device, in the second power conversion electric power from the power storage device being converted into feeding power to the power equipment;
a first clock configured to detect a current time; and
a first control device configured to control at least one of a charging operation and a power feeding operation using the power converter,
the power equipment including:
a second control device configured to control at least one of a supply operation and a reception operation, in the reception operation the charging power being supplied to the vehicle to charge the power storage device, in the reception operation the feeding power being received from the vehicle; and
a second clock configured to detect a current time,
the first and second control devices being configured to:
formulate at least one of a charging schedule that defines a start time of charging from the power equipment to the power storage device and a power feeding schedule that defines a start time of power feeding from the power storage device to the power equipment,
obtain a time lag between the first and second clocks when the vehicle and the power equipment are electrically connected by the connection member, and
in accordance with the time lag, set a time difference between a first charging start time in the vehicle and a second charging start time in the power equipment or a time difference between a first power feeding start time in the vehicle and a second power feeding start time in the power equipment,
the first control device starting the charging operation or the power feeding operation in the vehicle when the first charging start time or the first power feeding start time comes based on the current time detected by the first clock, and
the second control device starting the reception operation or the supply operation in the power equipment when the second charging start time or the second power feeding start time comes based on the current time detected by the second clock.

2. The power system according to claim 1, further comprising:
a signal generation circuit configured to generate a first signal output to the first control device and the second control device; and
a signal control circuit configured to cause a prescribed voltage change in the first signal in response to the connection member having been electrically connected between the vehicle and the power equipment, wherein
the first and second control devices obtain the time lag, based on the current time detected by each of the first and second clocks when the occurrence of the voltage change in the first signal is detected.

3. The power system according to claim 2, wherein
the connection member is configured by a power cable,
the power cable includes:
a connection node that removably contacts an electrical contact point provided in the vehicle; and
a connection detector configured to generate a second signal when the connection node is connected to the electrical contact point,
the signal generation circuit is mounted on the power cable and is configured to generate the first signal by using the electric power from the power equipment as a power source, and
the signal control circuit is mounted on the vehicle and is configured to cause the voltage change in the first signal in response to the generation of the second signal.

4. A vehicle having a power storage device mounted thereon, the vehicle comprising:
an inlet electrically connected via a connection member to power equipment placed external to the vehicle;
a power converter configured to execute at least one of first power conversion and second power conversion, in the first power conversion electric power supplied from the power equipment being converted into charging power of the power storage device, in the second power conversion electric power from the power storage device being converted into feeding power to the power equipment;
a clock configured to detect a current time; and
a control device configured to control power transmission between the vehicle and the power equipment,
the control device starting a charging operation or a power feeding operation, when detecting, based on the current time detected by the clock, that a charging start time or a power feeding start time has come,
a time difference being set between the charging start time and a charging start time in the power equipment or between the power feeding start time and a power feeding start time in the power equipment, and
each of the time difference being set in accordance with a time lag between the current time detected by the clock and a current time recognized by the power equipment, when the vehicle and the power equipment are electrically connected by the connection member.

5. The vehicle according to claim 4, wherein
a first signal is commonly input to the control device and to the power equipment,
the first signal is controlled such that a prescribed voltage change occurs in the first signal in response to the connection member having been electrically connected between the vehicle and the power equipment, and
in response to the occurrence of the voltage change in the first signal, the control device obtains the charging start time or the power feeding start time in the vehicle in a reflection of the time lag obtained with reception and transmission of information from and to the power equipment.

6. The vehicle according to claim 5, wherein
the connection member is configured by a power cable,
the power cable includes:
a connection node configured to removably contact the inlet;
a connection detector configured to generate a second signal when the connection node is connected to the inlet; and
a signal generation circuit configured to generate the first signal by using the electric power from the power equipment as a power source,
the vehicle further comprising
a signal control circuit configured to cause the voltage change in the first signal in response to the generation of the second signal.

7. Power equipment for executing at least one of a supply operation and a reception operation on a vehicle having a power storage device mounted thereon, in the supply operation charging power being supplied to the vehicle to charge the power storage device, in the reception operation feeding power being received from the vehicle; the power equipment comprising:
a power node electrically connected to the vehicle via a connection member;
a clock configured to detect a current time; and
a control device configured to control at least one of the supply operation and the reception operation,
the control device starting a charging operation or a power feeding operation, when detecting, based on the current time detected by the clock, that a charging start time or a power feeding start time has come,
a time difference being set between the charging start time and a charging start time in the vehicle or between the power feeding start time and a power feeding start time in the vehicle, and
each of the time difference being set in accordance with a time lag between the current time detected by the clock and a current time recognized by the power equipment, when the vehicle and the power equipment are electrically connected by the connection member.

8. The power equipment according to claim 7, wherein
a first signal is commonly input to the control device and to the vehicle,
the first signal is controlled such that a prescribed voltage change occurs in the first signal in response to the connection member having been electrically connected between the vehicle and the power equipment, and
in response to the occurrence of the voltage change in the first signal, the control device obtains the charging start time or the power feeding start time in the power equipment in a reflection of the time lag obtained with reception and transmission of information from and to the vehicle.

9. The power equipment according to claim 8, wherein
the connection member is configured by a power cable,
the power cable includes:
a connection node that removably contacts an electrical contact point provided in the vehicle;
a connection detector configured to generate a second signal when the connection node is connected to the electrical contact point; and
a signal generation circuit configured to generate the first signal by using the electric power from the power equipment as a power source, and
the vehicle includes a signal control circuit configured to cause the voltage change in the first signal in response to the generation of the second signal.
